(19) United States
(12) Patent Application Publication
(10) Pub. No.: US 2016/0065464 A1
(43) Pub. Date: Mar. 3, 2016

(54) MODEM, USER TERMINAL AND METHOD FOR SENDING MESSAGE

(71) Applicant: HON HAI PRECISION INDUSTRY CO., LTD., New Taipei (TW)

(72) Inventors: CHI-WEN CHENG, New Taipei (TW); CHEN-CHANG HO, New Taipei (TW)

(21) Appl. No.: 14/832,293

(22) Filed: Aug. 21, 2015

(30) Foreign Application Priority Data
Aug. 28, 2014 (TW) 103129641

(51) Int. Cl. H04L 12/741; H04W 72/10

(52) U.S. Cl. CPC H04L 45/74; H04W 72/10

(57) ABSTRACT

A modem capable of distributing IPv6 addresses upon request is connected to a user terminal. The user terminal requests and receives multiple IPv6 addresses from the modem, the IPv6 addresses including quality of service values corresponding to different priorities. The user terminal determines a range of quality of service required according to a priority of the message to be sent, and selects an IPv6 address with a quality of service value belonging to the determined range to send the message.

### CROSS-REFERENCE TO RELATED APPLICATIONS

This application claims priority to Taiwan Patent Application No. 103129641 filed on Aug. 28, 2014, the contents of which are incorporated by reference herein.

### FIELD

The subject matter herein generally relates to network communications.

### BACKGROUND

The Internet Protocol Version 6 (IPv6) is a development beyond Internet Protocol Version 4 (IPv4). In IPv6, the Global Unicast Address is divided into 3 portions, the first portion is global routing prefix which comprises 48 bits, the second portion is subnet ID which comprises 16 bits, and the third portion is interface ID which comprises 64 bits. IPv6 supports automatic configuration, resource precondition, and support applications requesting a certain bandwidth and time delay, such as in real-time video communication. At present, a modem selects proper data message service flow according to the content of the data message when receiving a data message from a user terminal, a lot of time is taken to process the step and affect the information transfer rate.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram of an application environment of a modem in accordance with one embodiment of the present disclosure.

FIG. 2 is a block diagram of an example functional module of a modem.

FIG. 3 is a block diagram of an example functional module of a user terminal.

FIG. 4 is a schematic diagram of one embodiment of sending a data message between modem and user terminal in accordance with the present disclosure.

FIG. 5 is a schematic diagram of one embodiment of an IPv6 in accordance with the present disclosure.

FIG. 6 is a flowchart of one example embodiment of a method of modem sending data message in accordance with the present disclosure.

FIG. 7 is a flowchart of one example embodiment of a user terminal sending a data message method in accordance with the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module” as used hereinafter, refers to logic embodied in hardware or firmware, or to a collection of software instructions, written in a programming language, such as, for example, Java, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

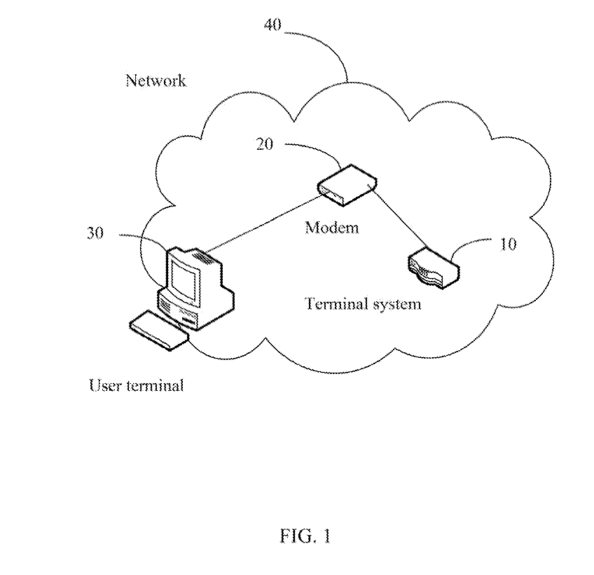

FIG. 1 is a diagram of an application environment of a modem in accordance with one embodiment of the present disclosure. In one embodiment, in the network 40, the modem 20 connects with the user terminal 30 and the terminal system 10. The modem 20 obtains configuration file from the terminal system 10, and completes internet protocol address configuration of the user terminal 30. The user terminal 30 receives IPv6 address distributed by the modem for transmitting a data message.

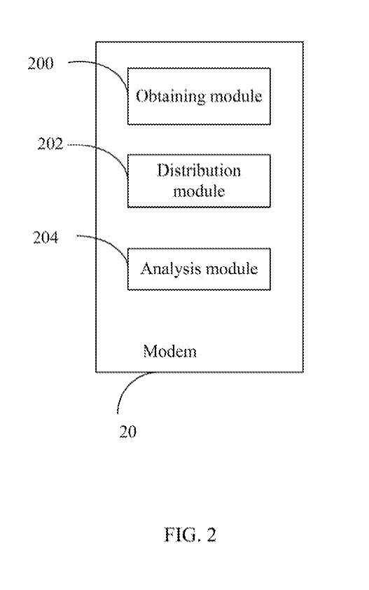

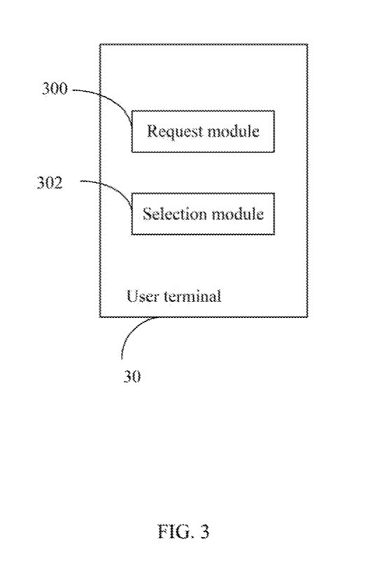

FIG. 2 is a block diagram of one embodiment of the modem 40 in FIG. 1. In the embodiment the modem 20 includes an obtaining module 200, a distribution module 202, and an analysis module 204. FIG. 3 is a block diagram of one embodiment of user terminal 30 in FIG. 1. In the embodiment, the user terminal 30 includes a request module 300 and a selection module 302.

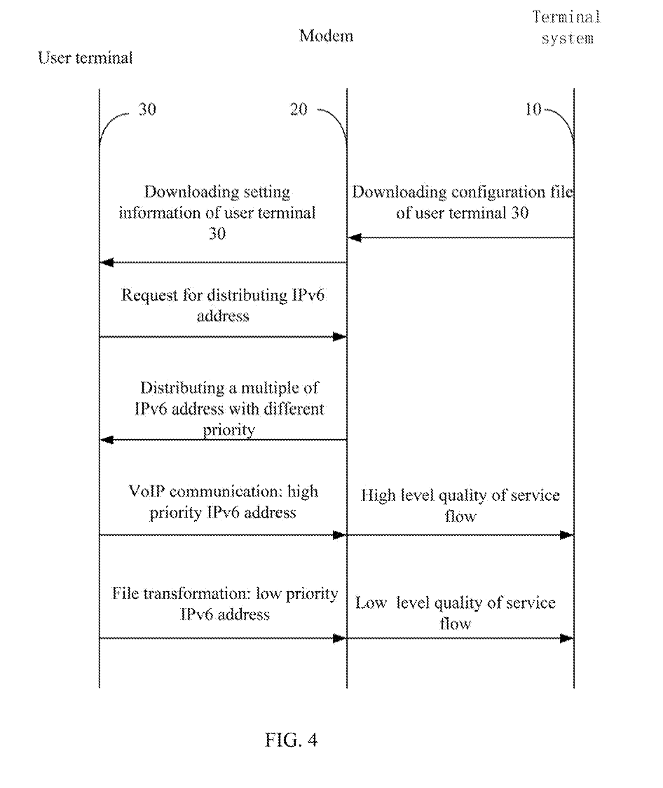

FIG. 4 is a diagram of one embodiment of the sending of a data message between modem and user terminal in accordance with the present disclosure. In the embodiment, the obtaining module 200 of the modem 20 obtains a configuration file from the terminal system 10. The configuration file includes multiple priorities and the service quality range to each priority set by terminal system 10 for user terminal 30. Different user terminals may have different priorities set by user according to the requirements or according to the cost of the user terminal. For example, distributing a high priority to the high cost user terminal and distributing a low priority to the low cost user terminal. Both a high and a low priority may be distributed to a user terminal.

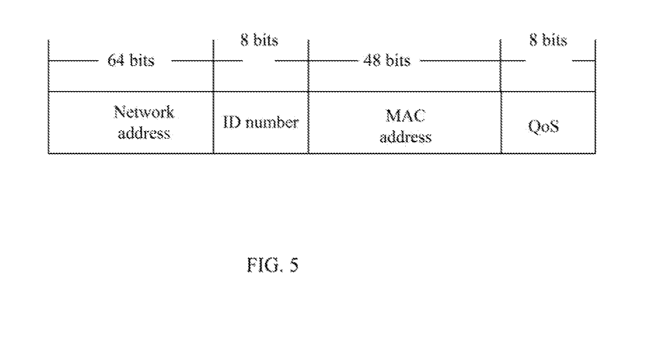

When the request module 300 of the user terminal 30 sends a message requesting the distribution of an IPv6 address, the distributing module 202 of the modem 20 receives the request and distributes relevant IPV6 address corresponding to each priority for the user terminal 30. The format of the relevant IPV6 address is shown in FIG. 5.

In FIG. 5, the format of the relevant IPV6 address includes 64 bits for network address, 8 bits for ID number, 48 bits for media access control (MAC) address, and 8 bits for quality of service (QoS). The distribution module 202 of modem 20 distributes 64 bits network address for global unicast address prefix, sets 8 bits of ID number as 0Xaf to distinguish the specific IPV6 address distributed from general IPV6 address, and sets the MAC address of the user terminal 30 to the 48 bits for MAC address of the distributed IPV6 address. The 48 bits MAC address comprises the 24 bits corporate identification and 24 bits extension identification. The distribution module 200 searches the configuration file to find out the priorities of the user terminal 30, sets the last two bits of the QoS as 1, and selects a QoS value within the QoS value range, wherein the QoS value range is relevant to each found priority. The selected QoS value is set to the remaining 6 bits of the QoS.

Users can automatically set different value ranges for the different priorities. For example, setting value range of 6 bits binary number from 2⁰ to (2⁴−1) corresponding to low priority, from 2⁴ to (2⁵−1) corresponding to medium priority, and from 2⁵ to (2⁶−1) corresponding to high priority. If the user terminal has both low and high priorities, the distribution module 202 randomly selects a QoS value from value range 2⁰ to (2⁴−1), and randomly selects a QoS value from value range 2⁵ to (2⁶−1). The distribution module 202 may for example randomly select numbers 000000 and 111111; the distribution module 202 would set the 111111 to the remaining 6 bits of the QoS to generate a high priority address, and would set the 000000 to the remaining 6 bits of the QoS to generate a low priority address. The set IPv6 address is then distributed to user terminal.

The difference between the distributed IPv6 address and current IPv6 address is 8 bits for identification and 8 bits for QoS. 64 bits for network address of the distributed IPv6 is the same as the current IPv6, the 48 bits for MAC address comprises the 24 bits corporate identification and 24 bits extension identification. Technology to change the MAC address to IPv6 address is current, so the distributed IPv6 address is compatible with current IPv6 address.

In FIG. 4, the request module 300 of user terminal 30 receives a plurality of IPv6 addresses comprising network address, MAC address, and QoS, and analyzes the QoS of the received IPv6. When the user terminal 30 needs to send data message, the selection module 302 of the user terminal 30 analyzes corresponding priority of the QoS in each received IPv6 address, and determines a quality service range of the data message according to the priority of the data message. An IPv6 is selected which has a QoS value belonging to the determined quality service range; and the selected IPv6 address is used to send the data message. For example, the selection module 302 selects a high priority IPv6 address when the data message is urgent, and selects a low priority IPv6 address when the data message is not urgent. Specifically, the selection module 302 chooses the distributed IPv6 address which comprises the QoS value 111111 to send the data message which is urgent. The selection module 302 chooses the distributed IPv6 address comprising the QoS value 000000 to send the non-urgent data message.

The analysis module 204 of the modem 20 receives data message sent by the user terminal, and analyzes 8 bits identification of the IPv6 address of the received data message. When 8 bits identification is found to be 0Xaf, the analysis module 204 continues to analyze the last two bits of the QoS. When the last two bits of the QoS are each 1, the analysis module 204 analyzes the remaining 6 bits of the QoS, and determines the value of 6 bits. The particular quality of service range to which the 6 bits value belongs is also determined, and a priority of the data message according to quality of service range is obtained. The service flow of corresponding service level to process the received data message is then employed.

The analysis module 204 sends the received data message as high service flow, when the modem determines that the quality of service in the IPv6 address of the received data message is high quality of service range. A data message is sent as medium service flow, when the modem determines that the quality of service in the IPv6 address of the received data message belongs to the medium quality of service range. A data message is sent as low service flow, when the modem determines that the quality of service in the IPv6 address of the data message belongs to low quality of service range.

According to previous example, the analysis module 204 sends the received data message as high service flow when the modem determines that 6 bits of QoS is 111111, and sends the data message as low service flow when the modem determines that 6 bits of QoS is 000000.

The quality of service concept in the present disclosure is different to that of class traffic and flow label in the current IPv6. Class traffic distinguishes between different types or priorities of IPv6 data message and calculates different priorities of class traffic by using different class traffic capacity experiments. The flow in flow label is specific data message (for example real-time audio and video data) from a specific source terminal to a specific end terminal, a data message belonging to one flow having the same flow label. Flow labelling is useful when transmitting real-time audio and video data, but has no purpose in transmitting non-urgent or non-real-time data (for example an email file). When non-urgent data is transmitted, the flow label is set as 0. The class traffic and flow label is automatically set by user, but the current modem does not to change the priority corresponding to QoS which is set by users. The priority of QoS is determined by the modem in this disclosure, and the modem can distribute different priorities of the IPv6 address. User terminal of modem can choose an appropriate priority for transmitting a data message. When the modem receives the data transmitted by the user terminal, the modem determines the service flow according to the priority of the IPv6 address of the transmitted data message, this saves time and improves the communication rate.

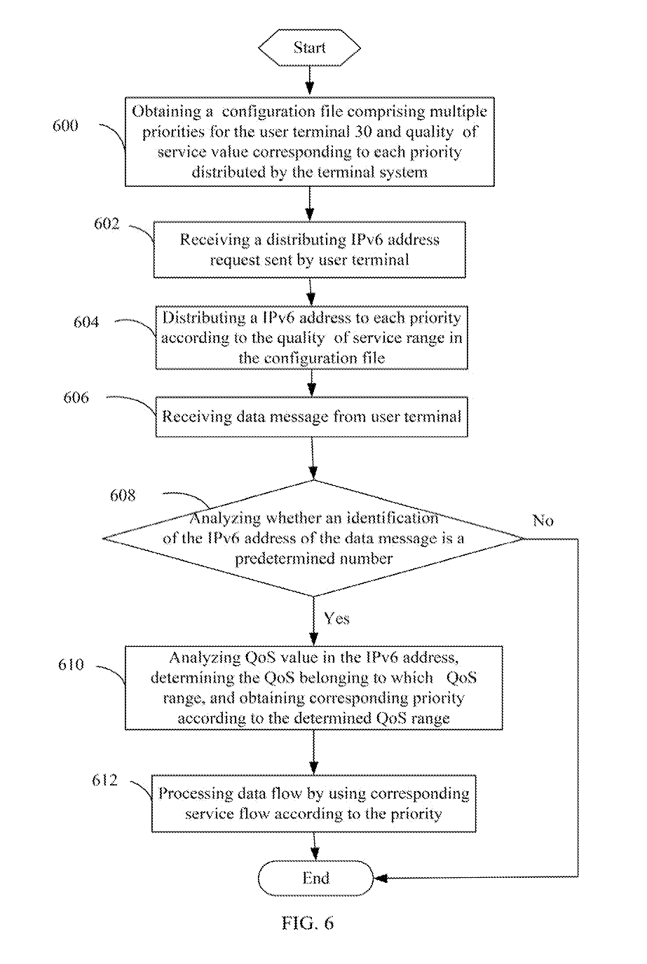

FIG. 6 is a flowchart of one example embodiment of a method for a modem sending data message in accordance with the present disclosure. The modem applied in the application environment is shown in FIG. 1.

In block 600, the obtaining module 200 of the modem 20 obtains a configuration file from the terminal system 10, the configuration file includes multiple priorities and the quality of service range applied to each priority which is set by terminal system 10 for user terminal 30.

Different user terminals have different priorities set by user according to requirements or according to the cost of the user terminal. For example, distributing a high priority to the high cost user terminal and distributing a low priority to the low cost user terminal. Both high and low priorities can be distributed to a user terminal.

In block 602, the distributing module 202 of the modem 20 receives a message requesting the distribution of an IPv6 address when the request module 300 of the user terminal 30 sends such request.

In block 604, the distributing module 202 of the modem 20 distributes relevant IPV6 address corresponding to each priority for the user terminal 30. The format of the relevant IPv6 address is shown in FIG. 5.

In block 606, the analysis module 204 of the modem 20 receives data message sent by the user terminal.

In block 608, the analysis module 204 of the modem 20 analyzes whether an identification number of the IPv6 address of the data message is a predetermined number. Specifically, the analysis module 204 analyzes the IPv6 address of the received data message, to establish whether 8 bits identification the IPv6 address of the received data message is 0Xaf. When 8 bits identification the IPv6 address of the received data message is 0Xaf, the analysis module 204 analyzes whether the last two bits of the QoS are each set as 1.

In block 610, the analysis module 204 analyzes QoS value in the IPv6 address, to determine the QoS range of the QoS value, and obtains a priority corresponding to the determined QoS range. Specifically, the analysis module 204 investigates whether the last two bits of the QoS are each set as 1. When the last two bits of the QoS are each set as 1, the analysis module 204 determines the remaining 6 bits QoS value in the IPv6 address, and calculates the value of 6 bits. A determination is made as to which quality of service range the 6 bits value belong to, and a priority of the data message according to quality of service range is obtained.

In block 612, the analysis module 204 employs the service flow of the corresponding service level to process the received data message. For example, the analysis module 204 sends the received data message as high service flow, when the modem determines that the quality of service in the IPv6 address of the data message belong to high quality (high priority) of service range. The analysis module 204 sends the data message as medium service flow, when the modem determines that the quality of service in the IPv6 address of the received data message belongs to medium quality (medium priority) of service range. The analysis module 204 sends the data message as low service flow, when the modem determines that the quality of service in the IPv6 address of the data message belongs to low quality (low priority) of service range.

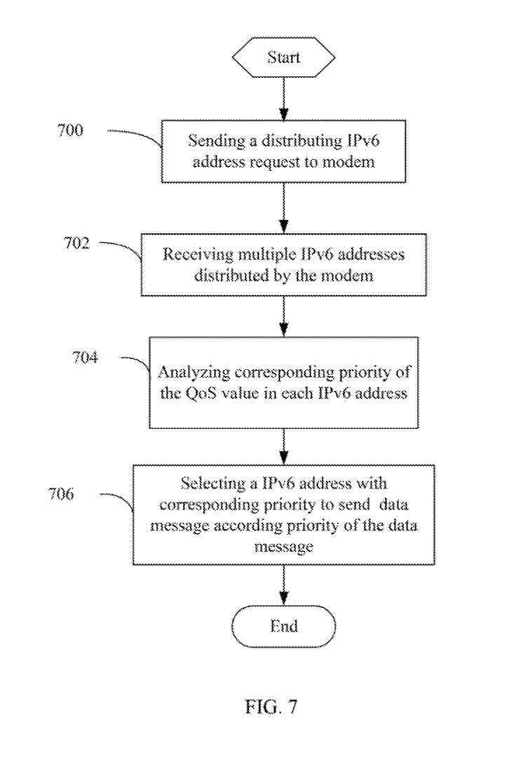

FIG. 7 is a flowchart of one example embodiment of a user terminal sending a data message method in accordance with the present disclosure. The user terminal applied in the application environment is shown in FIG. 1.

In block 700, the request module 300 of the user terminal 30 sends a message requesting the distribution of an IPv6 address.

The request module 300 of user terminal 30 receives a plurality of IPv6 addresses comprising network address, MAC address, and QoS, and analyzes the QoS of the received IPv6 addresses.

In block 704, when the user terminal 30 needs to send a data message, the selection module 302 analyzes priority of the QoS portion in each IPv6 address.

In block 706, the selection module 302 determines a quality service range of the data message according to the required priority of the data message, and selects an IPv6 which has a quality of service belonging to the determined quality service range. The selected IPv6 address is used to send the data message.

Many details are often found in the art such as the other features of a modem or a user terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A modem, connectable with a terminal system and a user terminal, the modem comprising:
at least one processor;
a storage system coupled to the processor, the storage system storing one or more programs executable by the at least one processor, the one or more programs comprising instructions for:
obtaining a configuration file from the terminal system, the configuration file including multiple priorities and quality of service corresponding to each priority distributed by the terminal system for the user terminal;
receiving a distribution Internet Protocol Version 6 (IPv6) address request from the user terminal;
distributing a corresponding IPv6 address for each priority of the user terminal, wherein each IPv6 address includes a quality of service value and the quality of service value in the quality of service range for corresponding priority;
receiving a data message sent by the user terminal;
determining a particular quality of service range to which the quality of service value of the IPv6 address belongs;
obtaining a priority of the received data message according to the quality of service range in the configuration file; and
employing the service flow corresponding to obtained priority to process the received data message.

2. The modem as claimed in claim 1, further comprising instructions for:
sending the data message to high service flow, when the modem determines that the quality of service value in the IPv6 address of the data message belongs to high quality of service range.

3. The modem as claimed in claim 1, wherein the modem further comprises instructions for:
sending the data message to low service flow, when the modem determines that the quality of service value in the IPv6 address of the data message belongs to low quality of service range.

4. The modem as claimed in claim 1, wherein the IPv6 address comprises an identification, the modem further comprises instructions for:
determining whether requesting to analyze the quality of service value of the IPv6 address of the received data message according to the identification.

5. The modem as claimed in claim 1, wherein the high priority is used for sending real time application data message.

6. The modem as claimed in claim 1, wherein the low priority is used for sending non-real time application data message.

7. A user terminal, connectable with a modem, the user terminal comprising:
at least one processor;
a storage system; and
one or more programs that are stored in the storage system and executed by the at least one processor, the one or more programs comprising instructions for:
sending a distributing Internet Protocol Version 6 (IPv6) address request information to the modem;
receiving multiple IPv6 address distributed by the modem, wherein each IPv6 address comprises a quality of service value;
determining a quality of service range of a data message according to the priority of the data message;
selecting a IPv6 whose quality of service belongs to the determined quality service range; and
using the selected IPv6 address to send the data message.

8. The user terminal as claimed in claim 7, further comprising instructions for:
selecting a high priority IPv6 address when the data message is in real-time data message.

9. The user terminal as claimed in claim 7, further comprising instructions for:
selecting a low priority IPv6 address when the data message is non-real time data message.

10. A method for sending message, applied in a modem connected with a user terminal, the method comprising:
obtaining a configuration file from the terminal system, the configuration file including multiple priorities and quality of service corresponding to each priority distributed by the terminal system for the user terminal;
receiving a distribution Internet Protocol Version 6 (IPv6) address request from the user terminal;
distributing a corresponding IPv6 address for each priority of the user terminal, wherein each IPv6 address includes a quality of service value and the quality of service value in the quality of service range for corresponding priority;
receiving data message sent by the user terminal;
determining a particular quality of service range to which the quality of service value of the IPv6 address belongs;
obtaining a priority of the received data message according to the quality of service range in the configuration file; and
employing the service flow corresponding to obtained priority to process the received data message.

11. The method as claimed in claim 10, further comprising:
sending the data message to high service flow, when the modem determines that the quality of service value in the IPv6 address of the data message belongs to high quality of service range.

12. The method as claimed in claim 10, further comprising:
sending the data message to low service flow, when the modem determines that the quality of service value in the IPv6 address of the data message belongs to low quality of service range.

13. The method as claimed in claim 10, wherein the IPv6 address comprises an identification, wherein the method further comprises: determining whether requesting to analyze the quality of service value of the IPv6 address of the received data message according to the identification.

14. The method as claimed in claim 10, wherein the high priority is used for sending real time application data message.

15. The method as claimed in claim 10, wherein the low priority is used for sending non-real time application data message.

16. A sending message method for a user terminal, the user terminal connected with a modem, the method comprising:
sending a distributing Internet Protocol Version 6 (IPv6) address request information to the modem;
receiving multiple IPv6 address distributed by the modem, wherein each IPv6 address comprises a quality of service value;
determining a quality of service range of a data message according to the priority of the data message;
selecting a IPv6 whose quality of service belongs to the determined quality service range; and
using the selected IPv6 address to send the data message.

17. The method as claimed in claim 16, further comprising:
selecting a high priority IPv6 address when the data message is in real-time data message.

18. The method as claimed in claim 16, further comprising:
selecting a low priority IPv6 address when the data message is non-real time data message.
